(19) United States
(12) Patent Application Publication
(10) Pub. No.: US 2012/0168011 A1
(43) Pub. Date: Jul. 5, 2012

(54) LIQUID DELIVERY SYSTEM

(75) Inventors: John R. Newton, Vero Beach, FL (US); Michael C. Cheney, Vero Beach, FL (US); Peter J. Brooke, Micco, FL (US)

(73) Assignee: Global Agricultural Technology and Engineering, LLC, Vero Beach, FL (US)

(21) Appl. No.: 12/983,443

(22) Filed: Jan. 3, 2011

(51) Int. Cl. F15D 1/00

(52) U.S. Cl. 137/565.01

(57) ABSTRACT

A liquid delivery system comprises a tank containing a supply of a first liquid. A positive displacement pump operates to withdraw the first liquid from the tank via a suction conduit and to deliver a pressurized flow of the first liquid via a delivery conduit. An adjustable metering orifice in the delivery conduit serves to control the flow of the first liquid through the delivery conduit. A normally closed first valve located in the delivery conduit between the pump and the metering orifice is opened in response to a pressure of the first liquid exceeding a threshold level, and is operative when open to deliver the first liquid to the metering orifice at a substantially constant pressure. A bypass conduit communicates with the tank and with the delivery conduit at a location between the pump and the first valve. A second valve in the bypass conduit is adjustable to accommodate a controlled return flow of the first liquid from the delivery conduit to the tank, thereby modulating the pressure of the first liquid being delivered to the first valve.

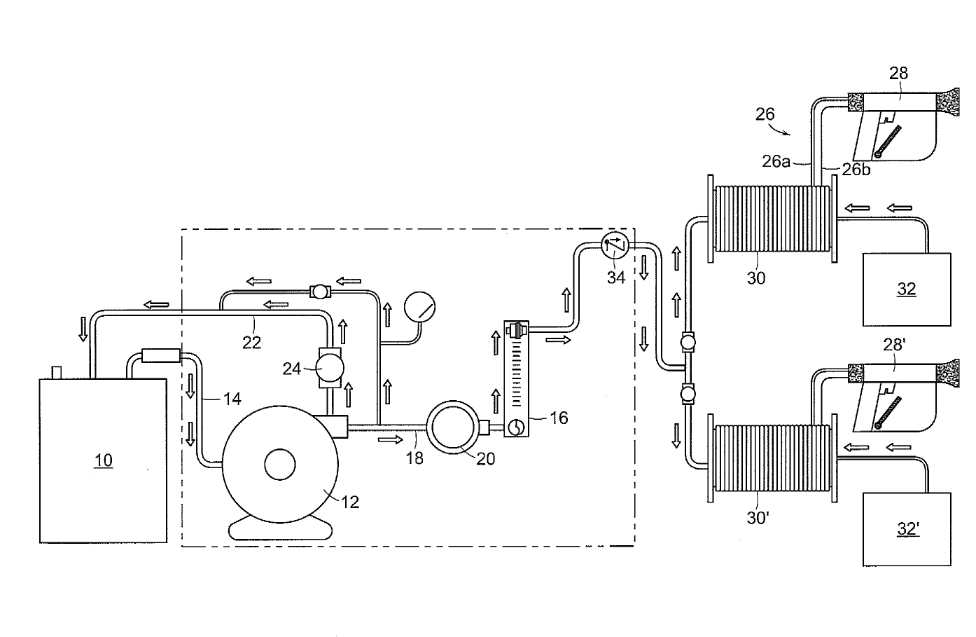

### BACKGROUND DISCUSSION

1. Field of the Invention

This invention relates generally to lawn treatment systems for alternatively applying either a water diluted fertilizer, or a mixture of the water diluted fertilizer and a liquid pest control product, e.g., an insecticide or pesticide.

2. Description of the Prior Art

Systems of the above-described type are known, as evidenced for example by the disclosure in U.S. Pat. No. 4,609,149. Such systems are typically truck or trailer mounted, with storage tanks containing the liquids to be dispensed, and pumps for delivering the liquids via separate hoses to a portable applicator gun which may be operated to apply a single liquid, e.g., water diluted fertilizer, or a mixture of the water diluted fertilizer and the liquid pest control product. While such systems operate in a generally satisfactory manner, they lack adequate means for precisely controlling the amount of pest control product being delivered to the applicator gun. This can result in either inadequate treatment, which allows insects and weeds to flourish, or over treatment, which can be harmful to the grasses being cultivated

The objective of the present invention is to address this shortcoming of the prior art, in addition to providing other important advantages.

### SUMMARY OF THE INVENTION

A system in accordance with the present invention comprises a tank containing a supply of a liquid pest control product, hereinafter referred to as the “first liquid”. A positive displacement pump operates to withdraw the first liquid from the tank via a suction conduit, and to deliver a pressurized flow of the first liquid via a delivery conduit. A metering orifice in the delivery conduit is adjustable to control the flow of the first liquid.

A first valve is located in the delivery conduit between the pump and the metering orifice. The first valve is normally closed, is opened in response to a pressure of the first liquid exceeding a threshold level, and when open, is operative to deliver the first liquid to the metering orifice at a substantially constant pressure.

A bypass conduit communicates with the tank and the delivery conduit at a location between the first valve and the pump. A second valve in the bypass conduit is adjustable to accommodate a controlled return flow of the first liquid from the delivery conduit to the tank, thereby modulating the pressure of the first liquid being delivered to the first valve.

Preferably, a pressure gauge is provided for visually displaying the pressure of the first liquid being delivered to the first valve, and the metering orifice also includes a visual display of the volume of the first liquid flowing through the delivery conduit.

In the disclosed embodiment, the system further comprises at least one delivery hose having first and second hose conduits leading to a handgun. The delivery conduit is connected to the first hose conduit, and the second hose conduit is connected to a pressurized source of a water diluted fertilizer, hereinafter referred to as a “second liquid”. The handgun is adapted to alternatively deliver only the second liquid, or a mixture of the first and second liquids.

These and other features and attendant advantages of the present invention will now be described in greater detail with reference to the accompanying drawings, wherein:

### BRIEF DESCRIPTION OF THE DRAWING

The drawing is a diagrammatic illustration of a system embodying the concepts of the present invention.

### DETAILED DESCRIPTION

The drawing diagrammatically depicts a system in accordance with the present invention for selectively dispensing either the second liquid or a mixture of the second liquid and the first liquid. Typically, the first liquid will comprise water diluted insecticide or fungicide and the second liquid will comprise a water diluted fertilizer.

A first tank 10 is adapted to contain a supply of the first liquid. A positive displacement pump 12 is operable to withdraw the first liquid from the tank 10 via a suction line 14 and to deliver a pressurized flow of the first liquid to a metering orifice 16 in a delivery conduit 18. The metering orifice is adjustable to control liquid flow, and includes a gauge for visibly displaying flow volume.

A first valve 20 is located in the delivery conduit 18. The first valve is of the constant flow type, examples of which are disclosed in U.S. Pat. Nos. 6,026,850; 6,208,578; 7,445,021 and 7,363,938, the descriptions of which are herein incorporated by reference. Valve 20 is normally closed, is opened in response to liquid pressure exceeding a threshold level, and is operative when open to deliver liquid to the metering orifice as a substantially constant pressure. Thus, depending on the adjusted size of the orifice, the volume of flow passing therethrough will remain substantially constant, thereby avoiding inadequate or excessive application of the water diluted chemical concentrate.

A bypass conduit 22 communicates with tank 10 and with the delivery conduit at a location between the pump 12 and the first valve 20. A second valve 24 in the bypass conduit is adjustable to accommodate a controlled return flow of the first liquid from the delivery conduit 18 to the tank 10. This return flow constantly agitates the tank contents while guarding against over pressurization of components downstream of the pump 12.

The system further comprises at least one delivery hose 26 leading to a portable handgun 28. The delivery hose is of a known type which includes first and second hose conduits 26a, 26b. The delivery hose is stored on a reel 30, with the first hose conduit 26a connected to the delivery conduit 18, and the second hose conduit 26b connected to a pressurized source 32 of the second liquid. The handgun 28 is adapted to alternatively deliver only the second liquid, or a mixture of the first and second liquids.

In the illustrated embodiment, a second hose reel 30′, handgun 28′ and pressurized source 32′ of a different second liquid are included. A check valve 34 prevents back flow in the delivery conduit 18.

We claim:

1. A system for delivering a metered flow of a first liquid, said system comprising:
a tank containing a supply of the first liquid;
a positive displacement pump, said pump being operable to withdraw said first liquid from said tank via a suction conduit and to deliver a pressurized flow of said first liquid via a delivery conduit;
a metering orifice in said delivery conduit, said metering orifice being adjustable to control the flow of said first liquid through said delivery conduit;
a first valve located in said delivery conduit between said pump and said metering orifice, said first valve being normally closed, being opened in response to a pressure of said first liquid exceeding a threshold level, and being operative when open to deliver said first liquid to said metering orifice at a substantially constant pressure;
a bypass conduit communicating with said tank and with said delivery conduit at a location between said pump and said first valve; and
a second valve in said bypass conduit, said second valve being adjustable to accommodate a controlled return flow of said first liquid from said delivery conduit to said tank, thereby modulating the pressure of the first liquid being delivered to said first valve.

2. The system of claim 1 further comprising a pressure gauge for visually displaying the pressure of the first liquid being delivered to said first valve.

3. The system of claim 1 or 2 wherein said metering orifice includes a visual display of the volume of said first liquid flowing through said delivery conduit.

4. The system of claim 1 further comprising at least one delivery hose having first and second hose conduits leading to a handgun, said delivery conduit being connected to said first hose conduit, and said second hose conduit being connected to a pressurized source of a second liquid, said handgun being adapted to alternatively deliver only said second liquid, or a mixture of said first liquid and said second liquid.
